(19) United States
(12) Patent Application Publication
(10) Pub. No.: US 2024/0327007 A1
(43) Pub. Date: Oct. 3, 2024

(54) MOVING OBJECT

(71) Applicant: HONDA MOTOR CO., LTD., Tokyo (JP)

(72) Inventors: Azuki Ichikawa, Wako-shi (JP); Yuichi Fukuchi, Wako-shi (JP); Masaru Tomimatsu, Wako-shi (JP); Takuya Kubota, Wako-shi (JP); Hikari Hirayanagi, Wako-shi (JP)

(21) Appl. No.: 18/621,782

(22) Filed: Mar. 29, 2024

(30) Foreign Application Priority Data
Mar. 30, 2023 (JP) 2023-055332

(51) Int. Cl. B64D 27/357; B64D 13/06; B64D 33/10

(52) U.S. Cl. CPC B64D 27/357; B64D 13/06; B64D 33/10

(57) ABSTRACT

A moving object includes equipment disposed in a first area and including an engine and a power generator driven by the engine, equipment disposed in a second area located forward of the first area in a traveling direction of the moving object and including an electric power device supplying electric power from the power generator to a battery, and equipment disposed in a third area located forward of the second area in the traveling direction and including the battery.

### CROSS-REFERENCE TO RELATED APPLICATIONS

This application is based upon and claims the benefit of priority from Japanese Patent Application No. 2023-055332 filed on Mar. 30, 2023, the contents of which are incorporated herein by reference.

### BACKGROUND OF THE INVENTION

### Field of the Invention

The present disclosure relates to a moving object.

### Description of the Related Art

US 2020/0115045 A1 discloses an aircraft. The aircraft includes a generator that generates electric power and a storage device that stores electric power. The storage device is located in the front of the aircraft fuselage with respect to the generator.

### SUMMARY OF THE INVENTION

A better moving object is desired.

An object of the present invention is to solve the above-mentioned problem.

An aspect of the present invention is characterized by a moving object including: equipment belonging to a first group; equipment belonging to a second group; and equipment belonging to a third group, wherein the equipment belonging to the first group is disposed in a first area, the equipment belonging to the second group is disposed in a second area, the second area being located forward of the first area in a traveling direction of the moving object, the equipment belonging to the third group is disposed in a third area, the third area being located forward of the second area in the traveling direction, the equipment belonging to the first group includes an engine and a power generator driven by the engine, the equipment belonging to the third group includes a battery, and the equipment belonging to the second group includes an electric power device configured to supply electric power from the power generator to the battery.

According to the present invention, the plurality of pieces of equipment provided in the moving object can be arranged suitably.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view showing a moving object according to an embodiment;

FIG. 2 is a plan view showing an inside of a fuselage; and

FIG. 3 is a side view showing the inside of the fuselage.

### DETAILED DESCRIPTION OF THE INVENTION

### Embodiment

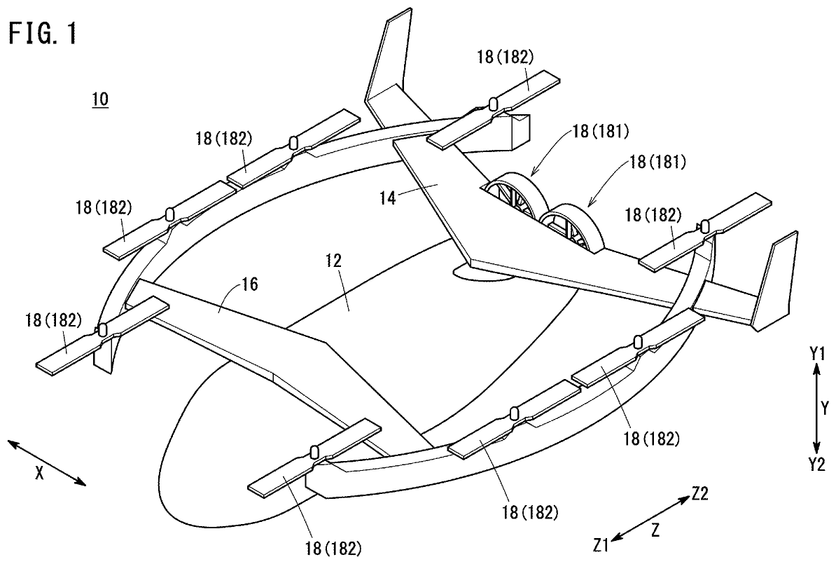

FIG. 1 is a perspective view showing a moving object 10 according to an embodiment. FIG. 1 shows a front-rear direction Z (Z1, Z2), a vertical direction Y (Y1, Y2), and a widthwise direction X. The front-rear direction Z, the vertical direction Y, and the widthwise direction X are orthogonal to each other. The downward direction Y2 indicates the gravity direction.

The moving object 10 is, for example, a vehicle that carries passengers. In the present embodiment, a case where the moving object 10 is an eVTOL (electric vertical take-off and landing aircraft) will be described, but the present invention is not limited thereto. Note that the eVTOL belongs to an aircraft.

The moving object 10 includes a fuselage (body) 12. The moving object 10, which is an eVTOL, may further include a main wing 14, which is a fixed wing, a front wing 16 disposed forward of the main wing 14, a plurality of electric rotary wings (rotors) 18, and a plurality of rotor drive motors (not shown).

The plurality of rotors 18 includes a plurality of cruise rotors 181 and a plurality of lift rotors 182. The cruise rotor 181 is a rotor 18 for generating thrust along the forward direction Z1. The lift rotor 182 is a rotor 18 for generating thrust (lift) along the upward direction Y1.

The rotor drive motor (not shown) is a motor connected to the rotor 18. In other words, the rotor drive motor is the motor that generates thrust for the moving object 10.

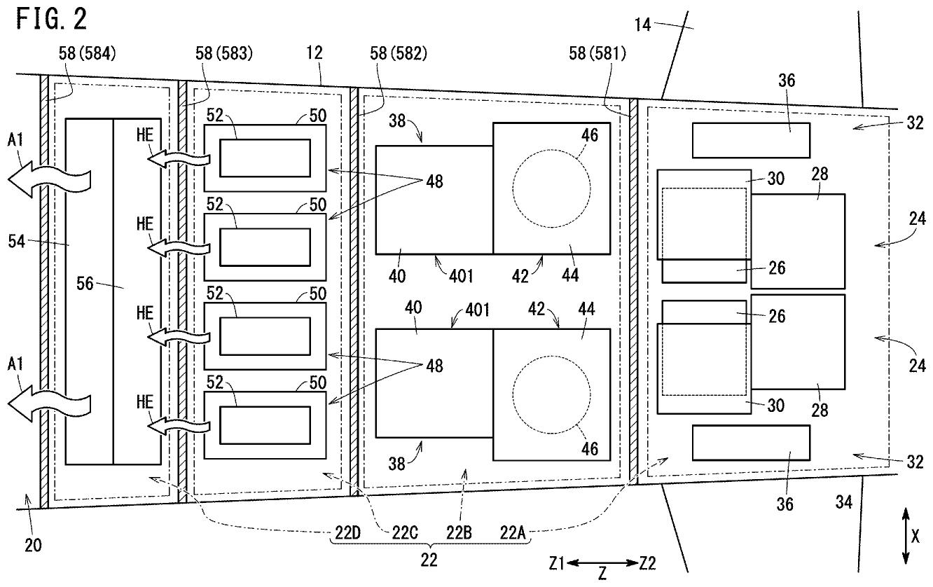

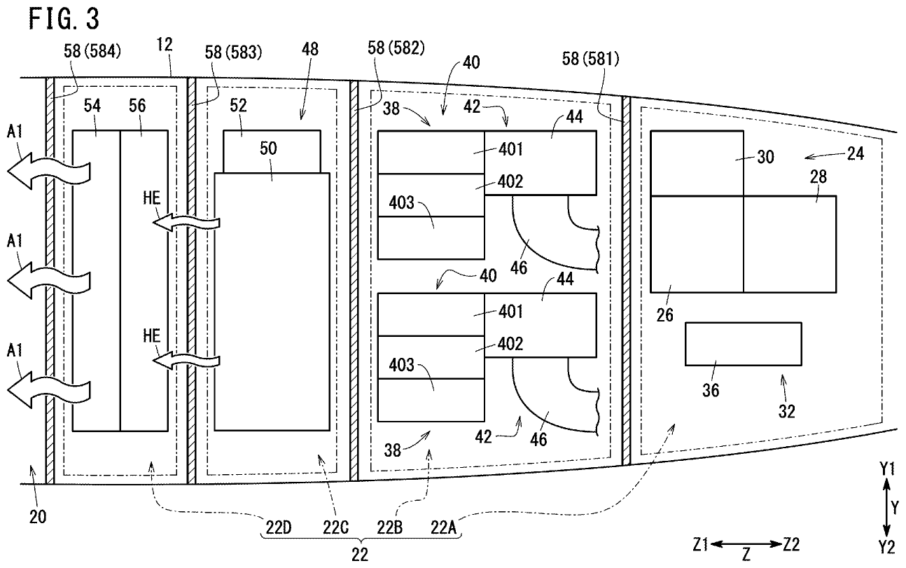

FIG. 2 is a plan view showing the inside of the fuselage 12. FIG. 3 is a side view showing the inside of the fuselage 12.

A passenger compartment 20 and an equipment area 22 are provided inside the fuselage 12. The passenger compartment 20 is positioned forward of the equipment area 22.

The equipment area 22 includes a first area 22A, a second area 22B, a third area 22C, and a fourth area 22D. The second area 22B is located forward of the first area 22A. The third area 22C is located forward of the second area 22B. The fourth area 22D is located forward of the third area 22C.

Equipment (power generation module) 24 belonging to a first group is disposed in the first area 22A.

The equipment (equipment group) 24 includes a power generator 26, an engine 28, and a power control unit (PCU) 30. The power generator 26 is disposed forward of the engine 28. The PCU 30 is disposed forward of the engine 28. The power generator 26 is, for example, a motor generator. The engine 28, for example, is a gas turbine engine. The engine 28 drives the power generator 26. The PCU 30 includes a power conversion circuits such as an inverter and a converter. The PCU 30 adjusts electric power output from the power generator 26. For example, the power generator 26 generates alternating-current power (AC power). The PCU 30 can convert the AC power output from the power generator 26 into direct-current power (DC power).

A cooling device (first cooling device) 32 is further disposed in the first area 22A. The first cooling device 32 includes a radiator (first radiator) 36. The first radiator 36 cools the equipment 24 by using coolant. The coolant used by the first radiator 36 is cooled by, for example, outside air supplied to the first area 22A via a duct (not shown), but is not limited thereto.

The first area 22A is further provided with an exhaust pipe (not shown) and a mixer (not shown). The exhaust pipe is connected to the engine 28. Exhaust gas of the engine 28 is discharged through the exhaust pipe. The mixer connects the exhaust pipe connected to the engine 28 and the first radiator 36. This allows discharged air from the first radiator 36 to flow into the exhaust pipe. The temperature of the discharged air from the first radiator 36 is sufficiently lower than the temperature of the exhaust gas from the engine 28. Therefore, the temperature of the exhaust gas can be reduced by causing the discharged air from the first radiator 36 to flow into the exhaust pipe.

The exhaust gas of the engine (gas turbine engine) 28 generates a vortex flow. A location of the vortex flow is subjected to a negative pressure. The negative pressure is generated, and thus the discharged air of the first radiator 36 is naturally drawn into the exhaust pipe via the mixer described above. That is, according to the present embodiment, during the period in which the engine 28 is driven, the discharged air from the first radiator 36 is naturally drawn into the exhaust pipe. Therefore, according to the present embodiment, it is not necessary to install a blower or the like for sending the discharged air of the first radiator 36 to the exhaust pipe.

A plurality of pieces of equipment 24 may be disposed in the first area 22A. For example, a pair of pieces of equipment 24 may be disposed in the first area 22A. Thus, even if the power generation function of one of the pair of pieces of equipment 24 is limited, the other equipment 24 is not affected by the limitation. The pair of pieces of equipment 24 may be arranged adjacent to each other in the widthwise direction X, for example, but are not limited thereto.

A pair of first cooling devices 32 may be disposed in the first area 22A in correspondence to the pair of pieces of equipment 24. The pair of first cooling devices 32 cool different pieces of equipment 24.

The second area 22B will be described later. Equipment (electric power storage module) 48 belonging to a third group is disposed in the third area 22C.

The equipment 48 includes a battery 50 and a power distribution device 52. The battery 50 is connected to the power generator 26 via the PCU 30. The battery 50 can be charged with the electric power output from the power generator 26. The power distribution device 52 can distribute electric power to the rotor drive motors and the like. The electric power supplied from the power generator 26 and the battery 50 can be distributed to the rotor drive motors and the like via the power distribution device 52. The power distribution device 52 includes, for example, wiring (not shown) and a junction box (not shown) that houses the wiring.

A plurality of pieces of the equipment 48 may be disposed in the third area 22C. The plurality of pieces of equipment 48 are arranged adjacent to each other in the widthwise direction X, for example, but are not limited thereto. The above-described pair of power generators 26 may supply electric power to different batteries 50.

Equipment (power supply module) 38 belonging to a second group is disposed in the second area 22B.

The equipment 38 includes an electric power device 40. The electric power device 40 includes, for example, an inverter 401, a converter 402, and a switchboard 403, as shown in FIG. 3. The inverter 401 is connected to the power distribution device 52. Electric power supplied from the power generator 26 and the battery 50 is supplied to the power distribution device 52 via the inverter 401. Thus, as described above, the power distribution device 52 can distribute electric power to the rotor drive motors and the like. The switchboard 403 connects the converter 402 and electric loads (not shown) provided in the moving object 10. The electric loads include, for example, an electric load included in a low-voltage system. The converter 402 converts electric power supplied from the power generator 26 and the battery 50 into electric power for the low-voltage system and supplies the converted electric power to the switchboard 403. The switchboard 403 may distribute the supplied electric power for the low-voltage system to the above electric load. The number of electric loads (not shown) provided in the moving object 10 is not particularly limited.

The electric power device 40 includes a plurality of inverters 401. The plurality of inverters 401 supply electric power to different rotor drive motors.

A cooling device (second cooling device) 42 is further disposed in the second area 22B. The second cooling device 42 includes a radiator (second radiator) 44 and a duct 46. The second radiator 44 cools the rotor drive motors and the electric power device 40 by using coolant. The duct 46 takes in outside air and supplies the outside air to the second radiator 44. The coolant used by the second radiator 44 is cooled by the outside air supplied from the duct 46.

A plurality of pieces of the equipment 38 may be arranged in the second area 22B so as to be separated from each other. With this arrangement, even if the function of one of the plurality of pieces of equipment 38 arranged separately from each other is limited, the remaining equipment 38 is not affected by the limitation. The electric power devices 40 included respectively in the plurality of pieces of equipment 38 may supply electric power to different rotor drive motors. For example, four pieces of the equipment 38 are arranged adjacent to each other in the up-down and left-right directions, but the present invention is not limited thereto.

A plurality of second cooling devices 42 may be disposed in the second area 22B in correspondence to the plurality of pieces of equipment 38. The plurality of second cooling devices 42 cool different pieces of equipment 38.

An air conditioner 54 and a cooling device (third cooling device) 56 are disposed in a fourth area 22D located between the passenger compartment 20 and the third area 22C.

The air conditioner 54 is a device for controlling air conditioning of the passenger compartment 20. The third cooling device 56 is disposed between the air conditioner 54 and the third area 22C. The third cooling device 56 is, for example, a chiller (cooling water circulation device).

As described above, the battery 50 is disposed in the third area 22C. The third cooling device 56 recovers heat HE generated from the battery 50. Thus, the battery 50 is cooled. Since the third area 22C and the fourth area 22D are adjacent to each other, the third cooling device 56 and the battery 50 can be arranged so as to be relatively close to each other. Thus, the heat HE of the battery 50 can be suitably recovered by the third cooling device 56. The third cooling device 56 is connected to the air conditioner 54. The air conditioner 54 can perform air conditioning of the passenger compartment 20 using the heat HE of the battery 50 recovered by the third cooling device 56. For example, the air conditioner 54 can generate warm air A1 using the heat HE recovered by the third cooling device 56 and supply the warm air A1 to the passenger compartment 20.

At least a part of the warm air A1 may be supplied to the third area 22C. The temperature of the battery 50 rises to, for example, 50 degrees centigrade or higher. On the other hand, the temperature of the warm air A1 generated for heating the passenger compartment 20 is, for example, about 22 degrees centigrade. Therefore, even the warm air A1 generated for heating the passenger compartment 20 is highly likely to be usable as cooling air for the battery 50. By supplying air (the warm air A1) from the air conditioner 54 to the third area 22C, it is possible to cool the battery 50, the power distribution device 52, and the like.

Moreover, by sending the warm air A1 to the third area 22C, the pressure in the third area 22C can be increased. This can suppress air from flowing from the second area 22B toward the third area 22C. Therefore, for example, it is possible to prevent dust or the like which has entered the second area 22B via the above-described duct 46 from flowing into the third area 22C. As a result, the possibility that the battery 50, the power distribution device 52, and the like are adversely affected by the dust and the like is reduced.

As shown in FIGS. 2 and 3, the first area 22A and the second area 22B may be separated by a partition wall (bulkhead) 58 (581). Similarly, the second area 22B and the third area 22C may be separated by a partition wall 58 (582). The third area 22C and the fourth area 22D may be separated by a partition wall 58 (583). The fourth area 22D and the passenger compartment 20 may be separated by a partition wall 58 (584). At least one of the plurality of partition walls 58 may be omitted. At least one of the plurality of partition walls 58 may be provided so as to be openable and closable. Further, at least one of the plurality of partition walls 58 may be a fire protection wall.

The partition wall 582 prevents air from flowing from the second area 22B toward the third area 22C. In addition, the partition wall 582 and the partition wall 583 inhibit air from flowing out from the third area 22C, and thus serve to increase the pressure inside the third area 22C. Therefore, the partition wall 582 and the partition wall 583 can more reliably prevent the dust and the like that has entered the second area 22B from flowing into the third area 22C.

According to the moving object 10 described above, the equipment 24 related to power generation, the equipment 38 related to power supply, and the equipment 48 related to power storage are separately disposed in different areas (22A to 22C). This can suppress complication of the arrangement of equipment in the moving object 10. Further, since the plurality of modules (the equipment 24, the equipment 38, and the equipment 48) are configured in functional units of power generation, power supply, power storage, and the like, maintenance operations are easy to perform.

Moreover, the first cooling device 32 for cooling the equipment 24, the second cooling device 42 for cooling the equipment 38, and the third cooling device 56 for cooling the equipment 48 can be driven independently of each other. Therefore, even if the function of one of the first cooling device 32, the second cooling device 42, and the third cooling device 56 is limited, the remaining two cooling devices can avoid being limited.

The following Supplementary Notes are further disclosed in relation to the above embodiment.

### Supplementary Note 1

The moving object (10) includes the equipment (24) belonging to the first group, the equipment (38) belonging to the second group, and the equipment (48) belonging to the third group. The equipment belonging to the first group is disposed in the first area (22A), the equipment belonging to the second group is disposed in the second area (22B), the second area being located forward of the first area in the traveling direction of the moving object, the equipment belonging to the third group is disposed in the third area (22C), the third area being located forward of the second area in the traveling direction, the equipment belonging to the first group includes the engine (28) and the power generator (26) driven by the engine, the equipment belonging to the third group includes the battery (50), and the equipment belonging to the second group includes the electric power device (40) configured to supply electric power from the power generator to the battery. With this configuration, the plurality of pieces of equipment provided in the moving object can be arranged suitably.

### Supplementary Note 2

The moving object according to Supplementary Note 1 may further include the passenger compartment (20) located forward of the third area in the traveling direction, wherein the air conditioner (54) configured to perform air conditioning of the passenger compartment using heat (HE) generated from the battery may be disposed in the fourth area (22D), the fourth area being located between the passenger compartment and the third area. With this configuration, heat recovered from the battery is not wasted.

### Supplementary Note 3

In the moving object according to Supplementary Note 1 or 2, the equipment belonging to the second group may include the inverter (401) that drives the motor that generates thrust for the moving object.

### Supplementary Note 4

In the moving object according to Supplementary Note 3, the equipment belonging to the second group may include the radiator (44) for cooling the motor.

### Supplementary Note 5

In the moving object according to Supplementary Note 4, the equipment belonging to the second group may include the duct (46) through which outside air is supplied to the radiator.

### Supplementary Note 6

In the moving object according to any one of Supplementary Notes 1 to 5, the plurality of electric power devices may be arranged in the second area (22B) so as to be separated from each other. With this configuration, even if the function of one of the plurality of electric power devices is limited, the remaining electric power devices can avoid being limited.

### Supplementary Note 7

In the moving object according to any one of Supplementary Notes 1 to 6, the first area may include the pair of engines and the pair of power generators.

### Supplementary Note 8

In the moving object according to any one of Supplementary Notes 1 to 7, the equipment belonging to the third group may further include the power distribution device (52) for distributing electric power output from the battery and electric power output from the power generator.

Moreover, it should be noted that the present invention is not limited to the disclosure described above, but various configurations may be adopted therein without departing from the essence and gist of the present invention.

1. A moving object comprising: equipment belonging to a first group; equipment belonging to a second group; and equipment belonging to a third group, wherein
the equipment belonging to the first group is disposed in a first area,
the equipment belonging to the second group is disposed in a second area, the second area being located forward of the first area in a traveling direction of the moving object,
the equipment belonging to the third group is disposed in a third area, the third area being located forward of the second area in the traveling direction,
the equipment belonging to the first group includes an engine and a power generator driven by the engine,
the equipment belonging to the third group includes a battery, and
the equipment belonging to the second group includes an electric power device configured to supply electric power from the power generator to the battery.

2. The moving object according to claim 1, further comprising:
a passenger compartment located forward of the third area in the traveling direction,
wherein an air conditioner configured to perform air conditioning of the passenger compartment using heat generated from the battery is disposed in a fourth area, the fourth area being located between the passenger compartment and the third area.

3. The moving object according to claim 1, wherein
the equipment belonging to the second group includes an inverter configured to drive a motor configured to generate thrust for the moving object.

4. The moving object according to claim 3, wherein
the equipment belonging to the second group includes a radiator configured to cool the motor.

5. The moving object according to claim 4, wherein
the equipment belonging to the second group includes a duct through which outside air is supplied to the radiator.

6. The moving object according to claim 1, wherein
a plurality of the electric power devices are arranged in the second area so as to be separated from each other.

7. The moving object according to claim 1, wherein
the first area includes a pair of the engines and a pair of the power generators.

8. The moving object according to claim 1, wherein
the equipment belonging to the third group further includes a power distribution device configured to distribute electric power output from the battery and electric power output from the power generator.
